(19) United States
(12) Patent Application Publication
(10) Pub. No.: US 2022/0003393 A1
(43) Pub. Date: Jan. 6, 2022

(54) WEAPON MOUNTED LIGHT

(71) Applicant: Cory Starr, Boerne, TX (US)

(72) Inventor: Cory Starr, Boerne, TX (US)

(21) Appl. No.: 17/367,982

(22) Filed: Jul. 6, 2021

Related U.S. Application Data
(60) Provisional application No. 63/048,236, filed on Jul. 6, 2020.

(51) Int. Cl. F21V 21/088; F21S 9/02; F21V 23/04; F41G 1/35

(52) U.S. Cl. CPC F21V 21/088; F41G 1/35; F21V 23/04; F21S 9/02

(57) ABSTRACT

An example weapon mounted light comprises: a housing containing a power source; a light head assembly carried by the housing, the light head assembly includes a light emitter; a rocker switch assembly that serves as an ON/OFF actuator for the light emitter carried by the light head assembly; and a back cover. A portion of the rocker switch assembly is received within a circular opening in a back end of the housing and held there by the back cover, the rocker switch assembly can be rotated clockwise and counterclockwise to actuate the light emitter. In some implementations, the weapon mounted light includes a clamping arrangement comprising a fixed clamp member that extends outwardly from the housing and a movable clamp member which is moveable toward and away from the fixed clamp member by a clamp screw.

### CROSS REFERENCE TO RELATED APPLICATION

This application claims the benefit of U.S. Provisional Application Ser. No. 63/048,236, filed on Jul. 6, 2020, the entirety of which is incorporated herein by reference.

### TECHNICAL FIELD

This disclosure relates to implementations of a weapon mounted light. In particular, the present invention is directed to implementations of a flashlight that can be secured to a mounting rail for firearm accessories.

### BACKGROUND

A weapon mounted light is a flashlight that can be attached to a firearm, leaving the operator free to use both hands to control the firearm. Weapon mounted lights are used for illumination, though some are equipped with a laser diode suitable for aiming. Weapon mounted lights typically have a light emitting diode (LED), the output of which is white light. Though, the use of an LED capable of generating infrared (IR) light is known.

Firearms, for example a handgun, rifle, or shotgun, are often equipped with a mounting interface for firearm accessories. Example mounting interfaces include the Universal rail and the Picatinny rail, well known to those of ordinary skill in the art. Some weapon mounted lights are configured for attachment to a handgun having a mounting interface on the dustcover of the frame, below the barrel. This positions the weapon mounted light to be substantially parallel with the longitudinal axis of the barrel. However, it should be understood that, such weapon mounted lights can also be attached to a rifle or shotgun equipped with the same, or similar, mounting interface.

Weapon mounted lights typically have one or more actuators used to turn the light and/or laser ON or OFF. Weapon mount lights configured for use with a handgun often have actuators that straddle the trigger guard and thereby facilitate operation of the light from either side of the handgun.

Accordingly, it can be seen that needs exist for the weapon mounted light disclosed herein. It is to the provision of a weapon mounted light configured to address these needs, and others, that the present invention is primarily directed.

### SUMMARY OF THE INVENTION

The weapon mounted light of the present disclosure can emit light when activated using a provided rocker switch assembly and be secured to a mounting rail for firearm accessories (e.g., a Universal rail or a Pica tinny rail). Such mounting rails are often found on firearms, such as handguns, rifles, and shotguns. The weapon mounted light is attached to a mounting rail by a clamping arrangement disposed on the mounting face of its housing.

An example weapon mounted light comprises: a housing in which is contained a power source; a light head assembly carried by the housing, the light head assembly includes a light emitter; a rocker switch assembly configured to serve as an ON/OFF actuator for the light emitter carried by the light head assembly; and a back cover. A portion of the rocker switch assembly is received within a circular opening in a back end of the housing and held there by the back cover, the rocker switch assembly can be rotated clockwise and counterclockwise to actuate the light emitter.

Another example weapon mounted light comprises: a housing in which is contained a power source; a light head assembly carried by the housing, the light head assembly includes a light emitter; a rocker switch assembly configured to serve as an ON/OFF actuator for the light emitter carried by the light head assembly; and a back cover. The housing includes a clamping arrangement comprising a fixed clamp member that extends outwardly from the housing and a movable clamp member which is moveable toward and away from the fixed clamp member by a clamp screw, the moveable clamp member moves transversely in a channel of the housing responsive to rotation of the clamp screw, a boss extending from the moveable clamp member is keyed to interface with the channel of the housing and thereby prevents the moveable clamp from rotating while being moved towards and away from the fixed clamp member.

Yet another example weapon mounted light comprises: a housing in which is contained a power source, the housing includes a circular opening and an annular contact flange, the circular opening is in a back end of the housing and the annular contact flange is positioned adjacent the circular opening; a light head assembly carried by the housing, the light head assembly includes a light emitter; a rocker switch assembly that serves as an ON/OFF actuator for the light emitter carried by the light head assembly, the rocker switch assembly comprising a switch actuator bar that can be used to rotate the rocker switch assembly, an actuator disk shaped to be received within the circular opening in the back end of the housing, and two blade contactors that are positioned back-to-back and thereby form a groove between each pair of adjacent ends, each groove is adapted to receive therein, and make contact with, a portion of the annular contact flange; and a back cover configured to hold the rocker switch assembly within the circular opening in the back end of the housing. The rocker switch assembly can be rotated clockwise and counterclockwise to actuate the light emitter

### BRIEF DESCRIPTION OF THE DRAWINGS

FIG. 1 illustrates an exemplary weapon mounted light according to the principles of the present disclosure.

FIG. 2 illustrates an exploded view of the weapon mounted light shown in FIG. 1.

FIGS. 3-5 illustrate the housing of the weapon mounted light shown in FIG. 1; wherein the moveable clamp member and clamp screw are shown exploded from the housing in FIG. 3.

FIGS. 6 and 7 illustrate the moveable clamp member of the housing shown in FIG. 3.

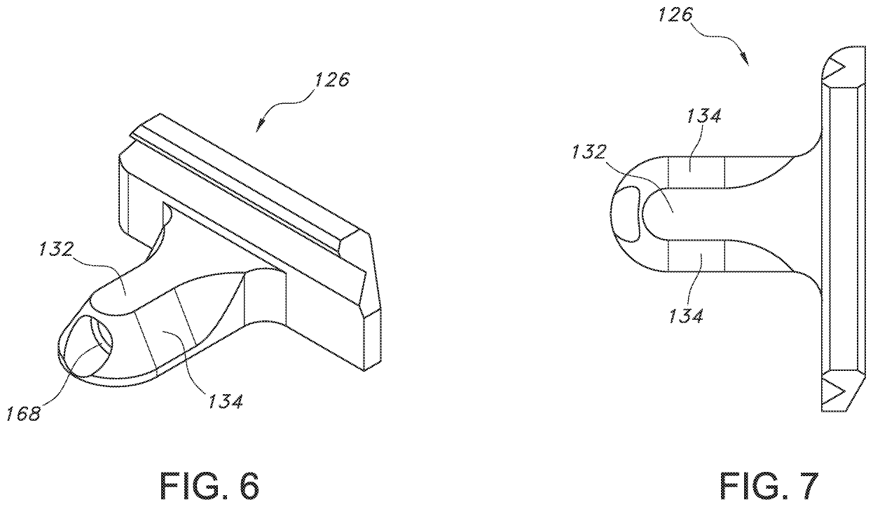

FIG. 8 illustrates the light head assembly of the weapon mounted light shown in FIG. 1.

FIGS. 9-12 illustrate the rocker switch assembly of the weapon mounted light shown in FIG. 1; wherein FIG. 9 is an exploded view of the rocker switch assembly.

FIGS. 13 and 14 illustrate the switch actuator bar of the rocker switch assembly shown in FIGS. 9-12.

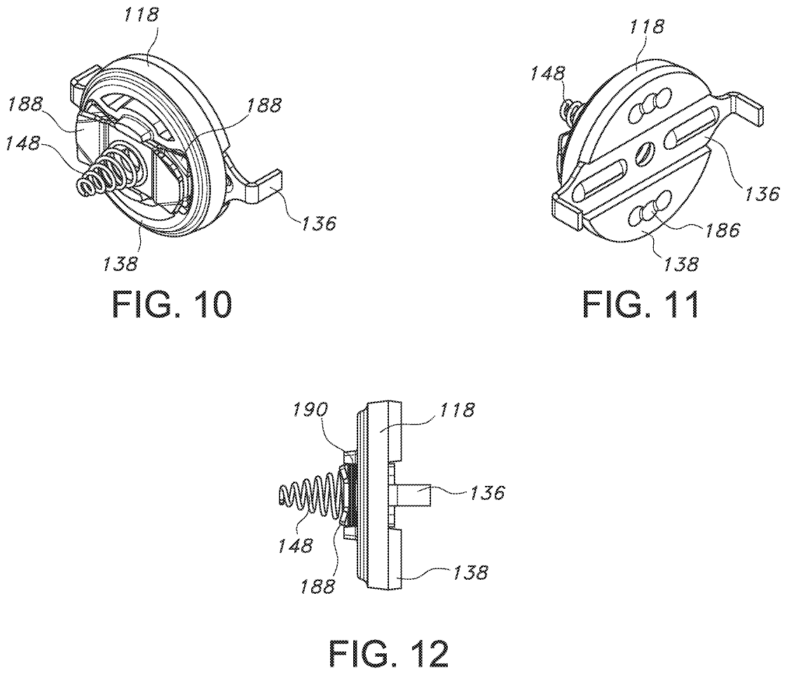

FIG. 15 illustrates an example blade contactor of the rocker switch assembly shown in FIGS. 9-12.

FIG. 16 illustrates the back cover of the weapon mounted light shown in FIG. 1.

FIG. 17 illustrates a cut-away view of the weapon mounted light shown in FIG. 1; wherein the light head assembly and back cover have been removed from the housing, and the paddles have been removed from the switch actuator bar.

FIG. 18 illustrates the weapon mounted light shown in FIG. 1, the rocker switch assembly is in the second rotational position.

FIG. 19 illustrates the weapon mounted light shown in FIG. 1, the rocker switch assembly is in the third rotational position.

Like reference numerals refer to corresponding parts throughout the several views of the drawings.

### DETAILED DESCRIPTION

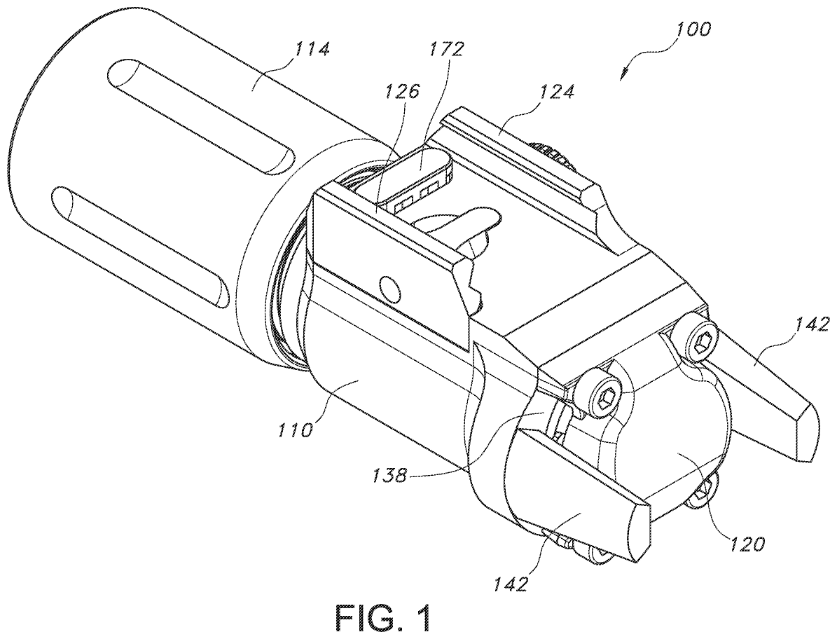

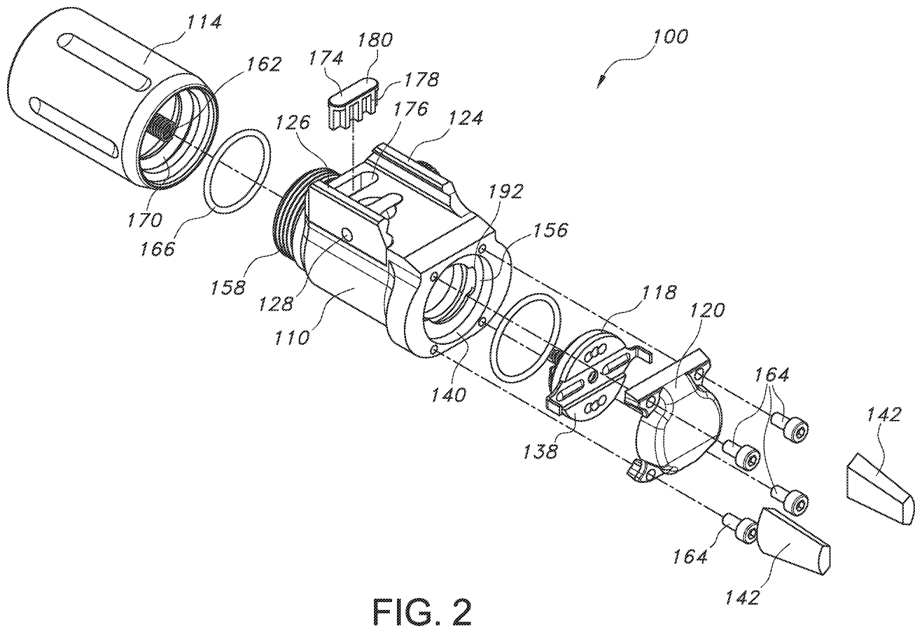

FIGS. 1 and 2 illustrate an example weapon mounted light 100 according to the principles of the present disclosure. The weapon mounted light 100 can emit light when activated using a provided rocker switch assembly 118 and be secured to a mounting rail for firearm accessories (e.g., a Universal rail or a Picatinny rail). Such mounting rails are often found on firearms, such as handguns, rifles, and shotguns. The weapon mounted light 100 is attached to a mounting rail by a clamping arrangement (124, 126, 128) disposed on the mounting face 160 of its housing 110. While secured to the mounting rail of a firearm, the weapon mounted light 100 is generally aligned parallel with a longitudinal axis of the firearm's barrel.

As shown in FIGS. 1 and 2, the weapon mounted light 100 comprises: a housing 110 in which is contained a power source, such as a battery cell (e.g., an 18350 Li—Mn battery cell); a light head assembly 114 carried by the housing 110, the light head assembly 114 includes a light emitter; a rocker switch assembly 118 that serves as an ON/OFF actuator for the light emitter carried by the light head assembly 114; and a back cover 120 that holds the rocker switch assembly in position.

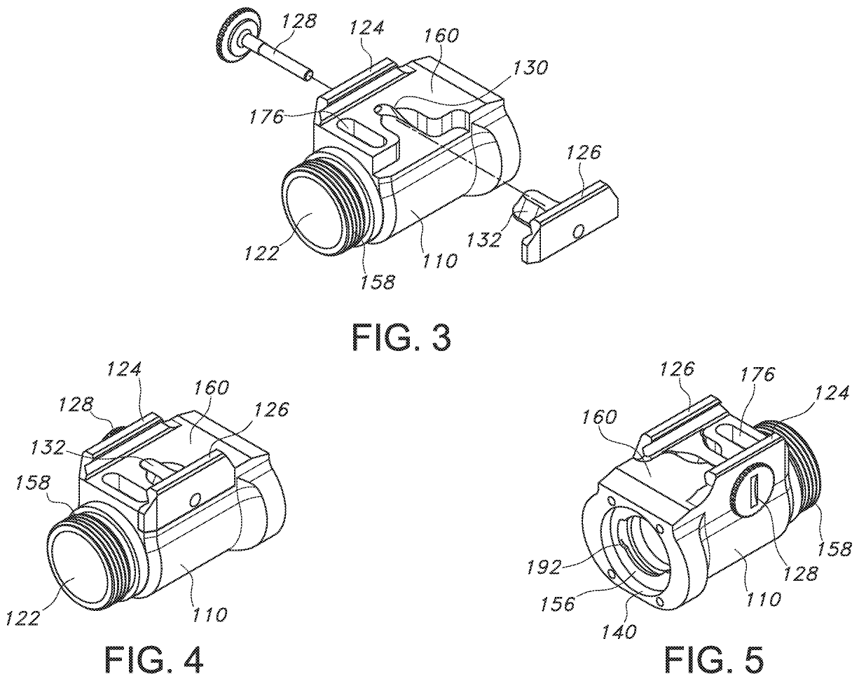

As shown in FIGS. 3 and 4, the housing 110 includes a battery compartment 122 and is configured so that the light head assembly 114 can be threaded onto a front end thereof. Specifically, the housing 110 includes a threaded extension 158 configured to receive the light head assembly 114. While the preferred implementation of the housing 110 is configured to contain a single power source (i.e., battery cell), it is contemplated that the housing 110 of a weapon mounted light could be configured to contain two battery cells. The housing 110 also includes a circular opening 140 in a back end thereof configured to receive a portion of the rocker switch assembly 118 therein. Adjacent the circular opening 140 is an annular contact flange 156 which forms part of the conductive path connecting the power source and the light emitter. The annular contact flange 156 includes two cutouts 192 disposed opposite each other, the purpose of which will be described below. The rocker switch assembly 118, in conjunction with the annular contact flange 156, is used to selectively close the electrical circuit of the weapon mounted light 110, thereby energizing the light emitter carried by the light head assembly 114.

As shown best in FIG. 3, the clamping arrangement of the housing 110 comprises a fixed clamp member 124 that extends outwardly from the housing 110 and a movable clamp member 126 which is moveable toward and away from the fixed clamp member 124 by a clamp screw 128. The fixed clamp member 124 and the moveable clamp member 126 define a cavity therebetween into which a mounting rail is placed for being engaged by the clamp members 124, 126. The moveable clamp member 126 moves transversely in a channel 130 of the housing 110 responsive to rotation of the clamp screw 128. Specifically, a boss 132 extending from the moveable clamp member 126 is keyed to interface with the channel 130 in the mounting face 160 of the housing 110. More specifically, the boss 132 includes beveled sidewalls 134 that interface with interior sidewalls defined by the channel 130 in the housing 110. In this way, the movable clamp member 126 is prevented from rotating (or twisting) while being moved towards and away from the fixed clamp member 124 by the clamp screw 128. The clamp screw 128 is disposed through a hole extending through the fixed clamp member 124 to engage a threaded hole 168 in and through the boss 132 of the moveable clamp member 126. Turning the clamp screw 128 in a clockwise direction causes the movable clamp member 126 to move transversely towards the fixed clamp member 124 (e.g., for engaging and clamping a mounting rail for firearm accessories therebetween). Turning the clamp screw 128 in a counterclockwise direction causes the moveable clamp 126 to move away from the fixed clamp member 124 (e.g., to release a mounting rail positioned therebetween). While the clamp screw 128 shown in FIG. 3 is a type of thumbscrew, in an alternate implementation, another screw type having a head which can be countersunk into an opening in the side of the fixed clamp member 124 may be used.

While the clamping arrangement (124, 126, 128) is effective for securing the weapon mounted light 100 against both transverse and longitudinal movement, the mounting face 160 of the housing 110 also includes a keying arrangement 172 that provides additional resistance to longitudinal movement. The keying arrangement 172 includes a rail lock 174 removably disposed in a recess 176 of the housing 110. The rail lock 174 includes a body 178 of similar size and shape to the recess 176 so as to be receivable therein. The rail lock 174 also includes a bar shaped protuberance 180, extending from the body 178, that is of a size and shape, and in a position, for engaging a transverse slot of the mounting rail to which the weapon mounted light 100 will be attached.

Mounting rails for firearm accessories can have different configurations. As such, a rail lock 174 is selected to have a protuberance 180 of corresponding size and shape, and position, to the keying feature of the mounting rail to which the weapon mounted light 100 is to be attached.

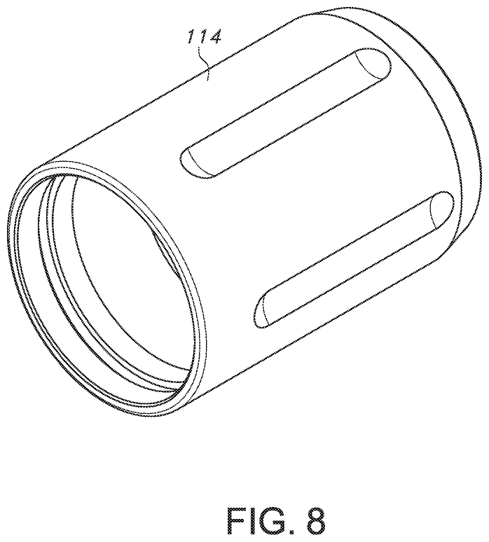

The light head assembly 114 shown in FIGS. 1, 2, and 8 includes the various elements required to provide the light beam emitted by the weapon mounted light 100. A preferred light head assembly 114 includes a light emitter such as a light emitting diode (LED), preferably a high luminous flux LED. Emitted light may be directed by a lens system contained in the light head assembly 114. The lens system includes an internal reflector that works in conjunction with a lens, preferably an Ultra clear BOROFLOAT® lens. One of ordinary skill in the art, having the benefit of the present disclosure, could select the various elements required to assemble a light head assembly 114 capable of emitting a light beam.

The back end of the light head assembly 114 includes internal threads 170 configured to threadedly engage with the threaded extension 158 of the housing 110. The threaded interface (158, 170) between the light head assembly 114 and the housing 110 may be sealed, e.g., by an O-ring 166, so as to resist entry of moisture and other undesirable substances. The light head assembly 114 also acts as a cover for an open end of the battery compartment 122 in the housing 110. The removable light head assembly 114 provides access to the battery compartment 122 within the housing 110, wherein a battery cell is positioned. In this way, the battery cell may be inserted and removed from the front end of the weapon mounted light 100.

The battery cell contained in the housing 110 provides electrical energy for operating the light head assembly 114. The light head assembly 114 and the rocker switch assembly 118 each include a battery contact spring (148, 162) that interfaces with the positive and negative terminals of a battery cell positioned within the battery compartment 122 of the housing 110.

As shown in FIGS. 1 and 2, the preferred implementation of the rocker switch assembly 118 permits ambidextrous actuation of the rocker switch assembly 118 for energizing the light emitter carried by the light head assembly 114. The rocker switch assembly 118 is configured to serve as an ON/OFF switch for the light emitter. But, in some implementations, the rocker switch assembly 118 may be configured to serve as a momentary ON switch for the light emitter (not shown).

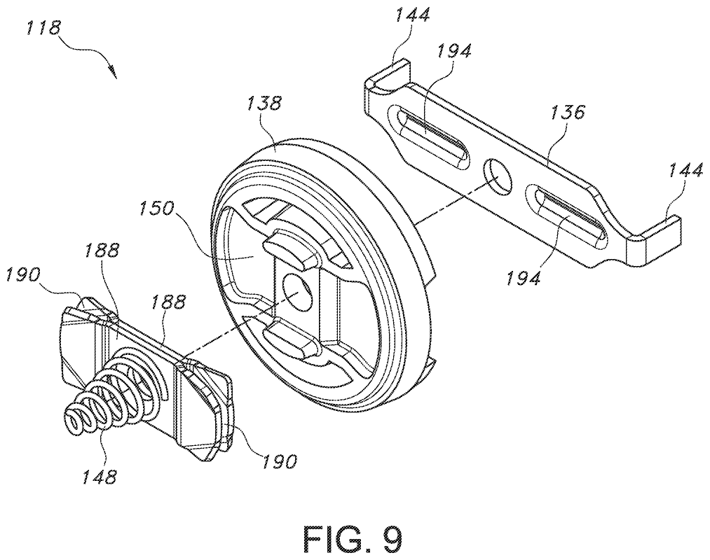

As shown best in FIGS. 9-12, the rocker switch assembly 118 comprises a switch actuator bar 136 (e.g., fabricated of stainless steel) affixed to an actuator disk 138 (e.g., fabricated of Delrin® polyoxymethylene). The actuator disk 138 is configured (i.e. shaped) so that it can be rotated, by the switch actuator bar 136, while positioned within the circular opening 140 in the back end of the housing 110. The switch actuator bar 136 includes two paddles 142 that extend rearwardly against which a user may press to cause the switch actuator bar 136, and the actuator disk 138 to which it is affixed, to rotate in the clockwise or counterclockwise direction, thereby actuating the light emitter carried by the light head assembly 114. The switch actuator bar 136 is press fit into a cutout in the actuator disk 138. But, in some implementations, an epoxy is used to secure the switch actuator bar 136 in the cutout of the actuator disk 138.

As shown best in FIG. 14, the back side of the switch actuator bar 136 includes two grooves 194 therein. These grooves 194 increase the rigidity of the switch actuator bar 136. Each groove 194 is positioned between a central opening 146 in the switch actuator bar 136 and a tab 144 extending from each end of the switch actuator bar 135.

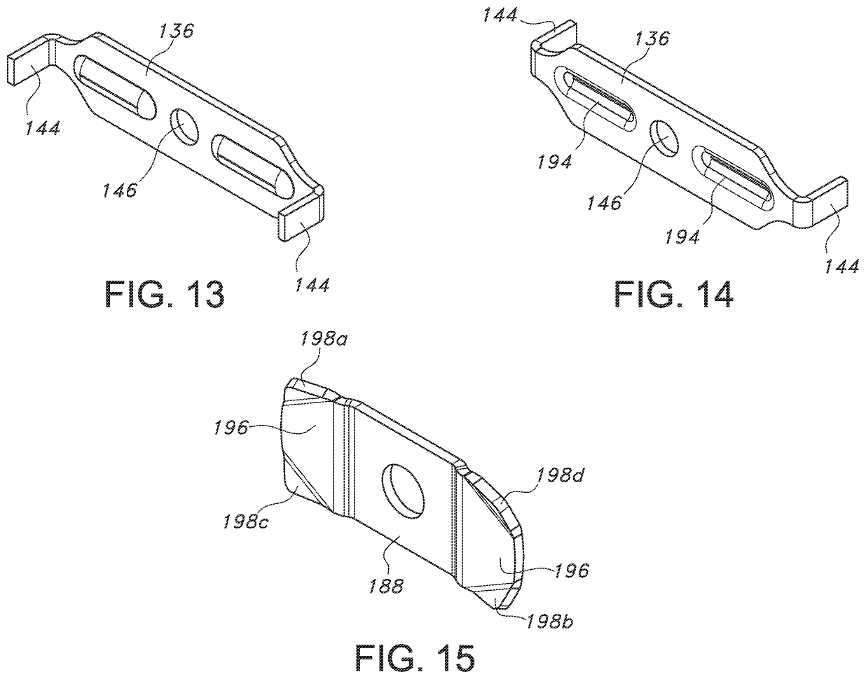

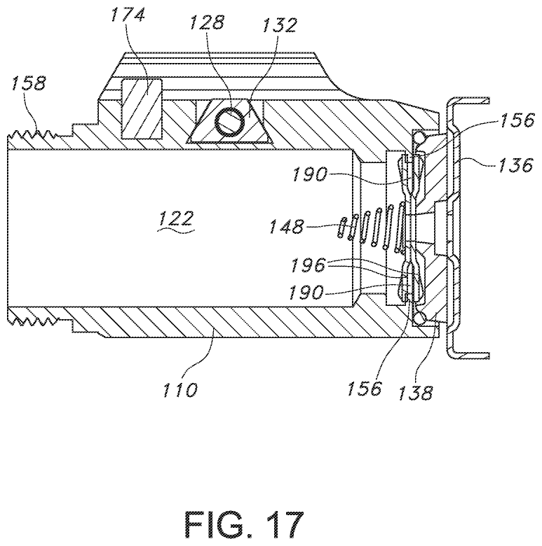

As shown best in FIGS. 9 and 10, the rocker switch assembly 118 further comprises two blade contactors 188 (e.g., each fabricated of stainless steel) held within a mating slot 150 on a front side of the actuator disk 138 by a screw and nut (not shown). The two blade contactors 188 are positioned back-to-back, thereby forming a groove 190 between adjacent ends 196. As shown best in FIG. 15, each end 196 of an exemplary blade contactor 188 is bent at a first angle, and both corners 198 of each end 196 are bent at a second angle. As shown in FIG. 17, when the rocker switch assembly 118 is rotated into position (i.e., the second or third rotational positions discussed below), each groove 190 formed between adjacent ends 196 of the blade contactors 188 is adapted to receive therein, and make contact with, a portion of the annular contact flange 156. In this way, the blade contactors 188 are placed into conductive contact with the annular contact flange 156. The battery contact spring 148, described above, is secured to the face of the superior blade contactor 188 by the same screw used to secure the two blade contactors 188 to the actuator disk 138. However, it should be understood that the battery contact spring 148 can be secured to the face of the superior blade contactor 188 using any suitable method known to those of ordinary skill in the art (e.g., soldered).

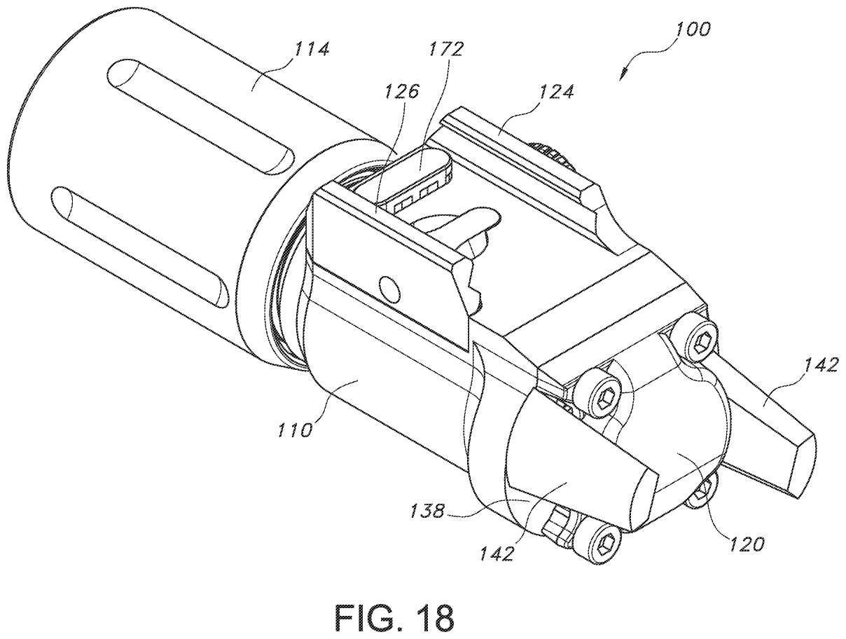

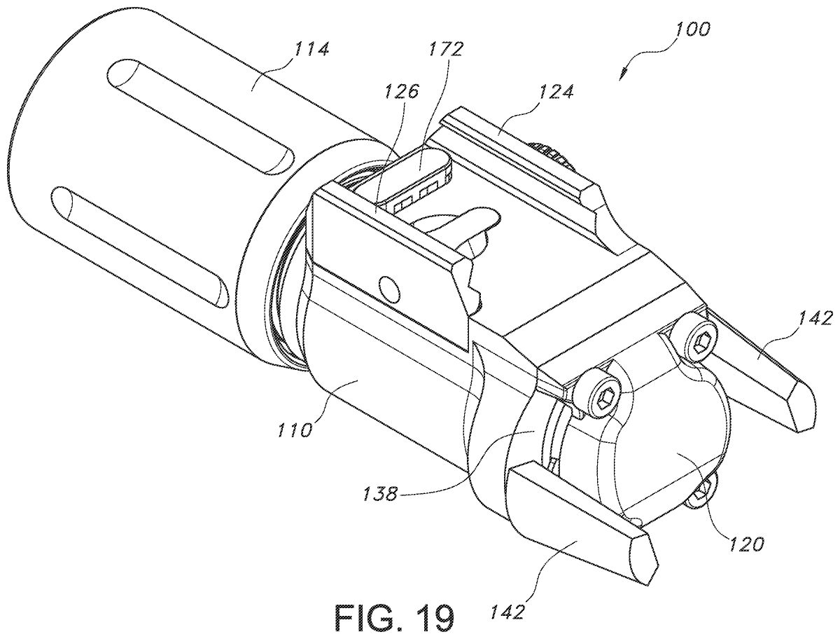

The rocker switch assembly 118 is rotatable, about a longitudinal axis, between a first rotational position where the switch actuator bar 136 is transversely oriented (see FIG. 1), a second rotational position where the switch actuator bar 136 is rotated clockwise by a predetermined angle (see, e.g., FIG. 18), and a third rotational position where the switch actuator bar 136 is rotated counterclockwise by a predetermined angle (see, e.g., FIG. 19). An operator may selectively rotate the switch actuator bar 136 into these three alternative positions by manipulating up or down either one of the paddles 142 attached to the ends of the switch actuator bar 136.

When the weapon mounted light 100 is fully assembled, the forward-facing battery contact spring 148 is in conductive contact with a terminal of a battery positioned within the housing 110. While the rocker switch assembly 118 is in the first rotational position, each end 196 of each blade contactor 188 is positioned within an interior cutout 192 of the annular contact flange 156. In this position, the blade contactors 188 make no contact with any portion of the annular contact flange 156. When a paddle 142 is used to rotate the switch actuator bar 136 to the second or third rotational position, two diagonally opposite corners (e.g., 198a & 198b or 198c & 198d) of each blade contactor 188 are rotated into conductive contact with the annular contact flange 156 in the back end of the housing 110 (see, e.g., FIG. 17). While these diagonally opposite corners 198 of the blade contactors 188 are held in contact with the annular contact flange 156, the electrical circuit of the weapon mounted light 100 is closed. In this way, the light emitter carried by the light head assembly 114 is energized (i.e., turned ON).

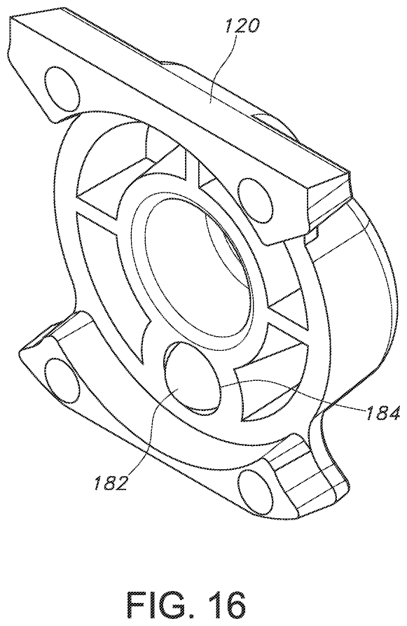

As shown in FIGS. 1 and 2, the back cover 120 of the weapon mount light 100 is used to hold the rocker switch assembly 118 in position within the circular opening 140 of the housing 110. As shown in FIG. 16, there is a spring-loaded ball detent 182 positioned in a socket 184 in the back cover 120. The spring-loaded ball detent 182 presses against an indentation 186 on the back side of the actuator disk 138, thereby providing tactile resistance to any rotational movement of the actuator disk 138 by the actuator switch bar 136. Further, due to resistance provided by the ball detent 182 being held in frictional engagement with one of the detent recesses 186 on the actuator disk 138, the spring-loaded ball detent 182 is able to releasably retain the actuator disk 138, and thereby the rocker switch assembly 118 as a whole, in either the first, second, or third rotational position.

Although not shown in the drawings, it will be understood that suitable wiring, traces, or a combination thereof, connect the electrical components (e.g., power source, light emitter, etc.) of the weapon mounted light 100 disclosed herein.

While not illustrated, in an alternate implementation, the rocker switch assembly 118 may be rotatably connected to the back cover 120 by a fastener that extends through the center of the switch actuator bar 136 and actuator disk 138. In such an implementation, the rocker switch assembly 118 rotates about the fastener connecting it to the back cover 120.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A weapon mounted light comprising:
a housing in which is contained a power source;
a light head assembly carried by the housing, the light head assembly includes a light emitter;
a rocker switch assembly that serves as an ON/OFF actuator for the light emitter carried by the light head assembly; and
a back cover;
wherein a portion of the rocker switch assembly is received within a circular opening in a back end of the housing and held there by the back cover, the rocker switch assembly can be rotated clockwise and counterclockwise to actuate the light emitter.

2. The weapon mounted light of claim 1, wherein the rocker switch assembly comprises a switch actuator bar affixed to an actuator disk shaped to be received within the circular opening in the back end of the housing.

3. The weapon mounted light of claim 2, wherein the switch actuator bar includes two grooves that increase rigidity.

4. The weapon mounted light of claim 2, wherein the rocker switch assembly further comprises two blade contactors affixed to a front side of the actuator disk, the two blade contactors are positioned back-to-back and thereby form a groove between adjacent ends.

5. A weapon mounted light comprising:
a housing in which is contained a power source;
a light head assembly carried by the housing, the light head assembly includes a light emitter;
a rocker switch assembly that serves as an ON/OFF actuator for the light emitter carried by the light head assembly; and
a back cover;
wherein the housing includes a clamping arrangement comprising a fixed clamp member that extends outwardly from the housing and a movable clamp member which is moveable toward and away from the fixed clamp member by a clamp screw, the moveable clamp member moves transversely in a channel of the housing responsive to rotation of the clamp screw, a boss extending from the moveable clamp member is keyed to interface with the channel of the housing and thereby prevents the moveable clamp from rotating while being moved towards and away from the fixed clamp member.

6. The weapon mounted light of claim 5, wherein the boss of the moveable clamp member includes beveled sidewalls that interface with interior sidewalls defined by the channel in the housing.

7. The weapon mounted light of claim 6, wherein the clamp screw is disposed through a hole extending through the fixed clamp member to engage a threaded hole in and through the boss of the moveable clamp member.

8. A weapon mounted light comprising:
a housing in which is contained a power source, the housing includes a circular opening and an annular contact flange, the circular opening is in a back end of the housing and the annular contact flange is positioned adjacent the circular opening;
a light head assembly carried by the housing, the light head assembly includes a light emitter;
a rocker switch assembly that serves as an ON/OFF actuator for the light emitter carried by the light head assembly, the rocker switch assembly comprising a switch actuator bar that can be used to rotate the rocker switch assembly, an actuator disk shaped to be received within the circular opening in the back end of the housing, and two blade contactors that are positioned back-to-back and thereby form a groove between each pair of adjacent ends, each groove is adapted to receive therein, and make contact with, a portion of the annular contact flange; and
a back cover configured to hold the rocker switch assembly within the circular opening in the back end of the housing;
wherein the rocker switch assembly can be rotated clockwise and counterclockwise to actuate the light emitter.

9. The weapon mounted light of claim 8, wherein the switch actuator bar includes two grooves that increase rigidity.

10. The weapon mounted light of claim 8, wherein the annular contact flange includes two cutouts disposed opposite each other.
